(19) United States
(12) Patent Application Publication
(10) Pub. No.: US 2026/0299909 A1
(43) Pub. Date: Oct. 1, 2026

(54) MECHANISM TO OPTIMIZE CODE TRANSLATION

(71) Applicant: Unisys Corporation, Blue Bell, PA (US)

(72) Inventors: Dheeraj SHARMA, Bangalore (IN); David STRONG, Irvine, CA (US)

(21) Appl. No.: 19/092,818

(22) Filed: Mar. 27, 2025

(51) Int. Cl. G06F 8/41

(52) U.S. Cl. CPC G06F 8/49

(57) ABSTRACT

Aspects herein describe optimized code translation. While dynamic binary code (DBT) translation provides optimized performance for those portions of code that are identified as hot paths, it can still lead to suboptimal performance for those portions of code that, while important to a program, are not identified as hot paths. Aspects herein provide the core mechanisms of DBT utilized today while also incorporating analysis of relationships between one or more code segments. Identification of code relationships allows for pre-translation of related code segments (i.e., translation prior to execution) while still utilizing the dynamic aspects of DBT to translate identified hot paths.

### BACKGROUND

A computing system generally includes a central processing unit that is configured to execute program instructions which are ordered and arranged to execute various tasks. Each central processing unit has a predefined set of instructions capable of execution on that system, referred to as an instruction set. The instruction set executable by a central processing unit defines the instruction set architecture of that central processing unit.

Often, it is desirable to run software written for a particular instruction set architecture (ISA) on a computing system that has a different, and potentially incompatible, instruction set architecture. To do so, software must be translated from the instruction set in which it is written to an instruction set compatible with the target central processing unit. This can be done in different ways. One example is what is referred to as ahead-of-time (AOT) translation which, as the name suggests, occurs before a program is executed. With AOT translation, the entire binary code is translated from a source ISA to a target ISA ahead of time. This translation is static and does not change. Dynamic binary translation (DBT) differs from AOT translation in that it occurs at runtime and the binary code is translated as the program executes. Typically, hot paths (i.e., a sequence of instructions or code paths that are executed frequently during runtime of a program) are identified and then translated dynamically. While hot paths may result in significant optimization from dynamic translation, less frequently executed code (e.g., cold paths) may experience sub-optimal translation, thus, having lower performance. This can lead to suboptimal performance for parts of the program that are not identified as hot paths but are still important. Additionally, programs with highly dynamic behavior may have varying hot paths depending on the input or data usage patterns. This variability can make it challenging to consistently identify and optimize the most critical paths. For these and other reasons, improvements are desirable.

### SUMMARY

At a high level, aspects herein describe optimized code translation. While dynamic binary code translation provides optimized performance for those portions of code that are identified as hot paths, it can still lead to suboptimal performance for those portions of code that, while important or even critical to a program, are not identified as hot paths. Code segments that are not identified as hot paths but still important may refer generally to code segments that are executed during runtime at a specific threshold that is less than that required to be identified as a hot path. In aspects, the specific threshold may be less than a hot path threshold but higher than a threshold for which cold paths are identified (i.e., code segments that are executed less than a predetermined cold threshold).

Conversely, static translation (e.g., AOT translation) is not dynamic in nature as is required with today's increased performance demands. Aspects herein provide the core mechanisms of DBT utilized today while also incorporating analysis of relationships between one or more segments of the code. Identification of code relationships allows for pre-translation (i.e., translation prior to runtime) of related code segments while still utilizing the dynamic aspects of DBT to translate identified hot paths.

This summary is intended to introduce a selection of concepts in a simplified form that is further described in the detailed description section of this disclosure. The summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through the practice of the technology.

### BRIEF DESCRIPTION OF THE DRAWINGS

The technology is described in detail below with reference to the attached drawing figures, wherein:

FIG. 1 is an illustration of a plurality of computing systems operating using incompatible instruction set architectures, in accordance with aspects described herein;

FIG. 2 is an illustration of a target computing system executing code from a non-native code stream; in accordance with aspects described herein;

FIG. 3 is an exemplary code segment relationship graph, in accordance with aspects described herein;

FIG. 4A is a depiction of an exemplary memory allocation, in accordance with aspects described herein;

FIG. 4B is a depiction on an exemplary co-located memory allocation, in accordance with aspects described herein;

FIG. 5 depicts an example process flow for optimizing translations, in accordance with aspects described herein; and

FIG. 6 illustrates an example computer device in which aspects of the technology may be employed.

### DETAILED DESCRIPTION

Aspects herein provide optimized code translations beyond the capabilities of conventional translation processes. Various implementations of translation are described in U.S. Pat. Nos. 8,600,727, 8,527,969, and 8,898,642, which are incorporated herein by reference in their entireties, except for any definitions, subject matter disclaimers or disavowals, and except to the extent that the incorporated material is inconsistent with the express disclosure herein, in which case the language in this disclosure controls.

In general, the present disclosure relates to executing a code stream of non-native binary code on a computer system. Non-native, as used herein, refers generally to a binary code stream received by a computing system that cannot be executed directly on the computing system without some type of translation, for example, with an emulator or other pre-execution translation system. In general, aspects herein provide increased efficiency in executing translated code streams using relationships therebetween and grouping translated code streams having relationships (e.g., related code segments) to one another in contiguous memory (e.g., memory blocks, memory segments, etc.). Accordingly, portions of the code streams that are not identified as hot paths but still important to the program are translated and stored efficiently in contiguous memory (i.e. a contiguous memory location such as the same page of memory) for quick access. This improves performance and efficiency.

Aspects of the technology described herein provide a number of improvements over existing technologies. For example, in typical DBT, hot paths are the primary means to identify which portions of a code stream to translate. Thus, other portions of code streams that are not hot paths (but not cold paths) may be overlooked in the translation process and not available when needed, resulting in delays and inefficiencies. Conversely, static translations are simply that: static. While requiring no runtime translation overhead, there is the significant disadvantage of being unable to optimize based on actual runtime behavior.

The technology described herein allows for translation without the risk of overlooking code segments in a program that are critical to the program performance. Hot paths, as used herein, are sequences of instructions or code paths that are executed a predetermined number of times during runtime of a program such that the predetermined number of times is greater than or equal to a predetermined hot path threshold. Exemplary hot paths may be loops in a program, performance-critical code, and the like. Cold paths, as used herein, are sequences of instructions or code paths that are not executed a predetermined number of times during runtime of a program and may be executed less than a predetermined cold path threshold. The technology described herein seeks to ensure identification of code segments that are not cold paths (i.e., they are executed a number of times greater than the predetermined cold path threshold) but do not rise to the level of a hot path (i.e., they are not executed a predetermined number of times greater than or equal to the hot path threshold) that are related to one or more other code segments, essential for hot path execution.

The technology described herein utilizes the core mechanism of dynamic translation (e.g., DBT) while also considering code stream relationships between one or more portions of the code stream (e.g., code segments). Relationships may refer to dependencies, function calls, control flow, and the like. Knowing the relationships between one or more portions of the code stream can allow for a hybrid approach to translation such that the related code segments are pre-translated prior to runtime and hot paths (any of which that are not already translated based on relationships) are translated in a dynamic fashion at runtime.

Although the distinction between hot paths and code relationships is subtle, it is indeed distinct. For example, code relationships are logical connections between code blocks while hot paths are simply frequently executed code sequences. Code relationships evaluate the entire code stream and the interactions therein while hot paths merely focus on the frequently executed sequences. Thus, hot paths sole determining factor is frequency and, thus, a predetermined threshold must be met to identify the hot path. Such a frequency limitation is not present with code relationships. It may be that related code segments are also hot paths or portions thereof, but a hot path threshold is not evaluated for pre-translation of related code segments.

Furthermore, identifying the relationships between one or more portions of code stream allows for intelligent memory allocation of the one or more portions of code stream. Specifically, the one or more portions of code stream can be stored in contiguous memory, such that the processor accesses the necessary portions of code stream quicker than if the one or more portions of code are stored in a disparate manner across memory.

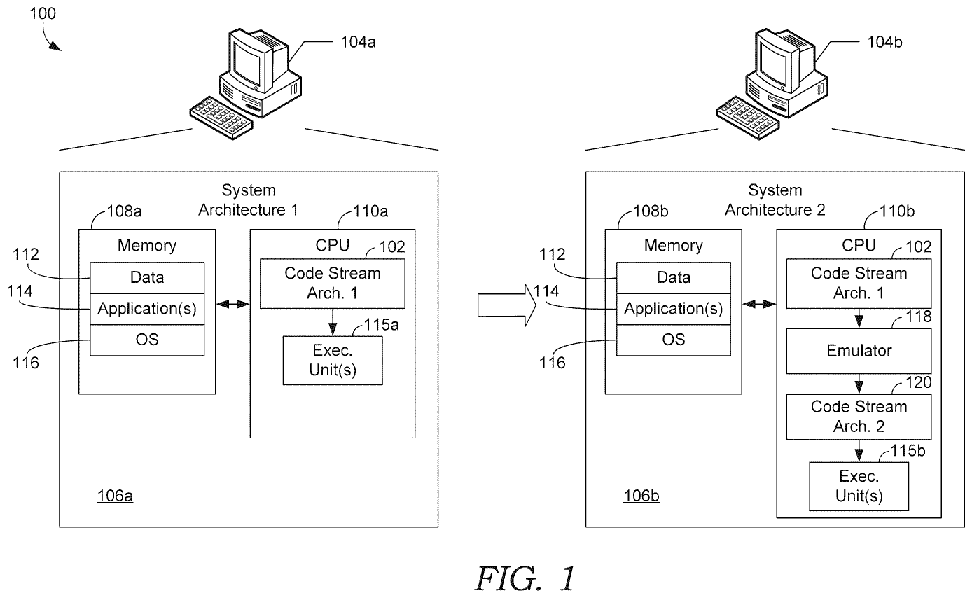

Turning to FIG. 1, a schematic illustration of a plurality of computing systems operating using incompatible instruction set architectures is shown. The illustration shown in FIG. 1 is intended to illustrate execution of a code stream 102 on two computing systems, shown as computing system 104a and computing system 104b, using different and incompatible instruction set architectures. In other words, while code stream 102 executes natively on hardware provided as part of computing system 104a, it is non-native to computing system 104b, meaning that the computing system 104b operates using a different set of instructions that that of computing system 104a and cannot natively execute those instructions, or operators, included in code stream 102.

In further detail regarding the distinction between native and non-native execution of a code stream, computing system 104a has a first system architecture 106a and computing system 104b has a second system architecture 106b. Computing system 104a includes a memory 108a and processing unit 110a, while computing system 104b includes a memory 108b and a processing unit 110b.

Each of memory 108a and memory 108b includes a variety of different stored information, including data 112, applications 114, and an operating system 116. On computing system 104a, the operating system executes natively using the first system architecture 106a, and controls operation of the applications 114 and access to data 112. The resulting code stream 102 represents a sequence of binary operations and data that are parsed and executed on the computing system 104a, within one or more execution units 115a of the processing unit 110a.

The same data 112, applications 114, and operating system 116 can be stored in memory 108b and can form code stream 102, but that code stream 102 cannot directly be executed by the processing unit 110b. Rather, the code stream 102 is passed to an emulator 118, which converts the code stream 102, which is non-native with respect to second system architecture 106b, to a second code stream 120, which is native to second system architecture 106b. The second code stream 120 can be executed on execution unit 115b of the processing unit 110b.

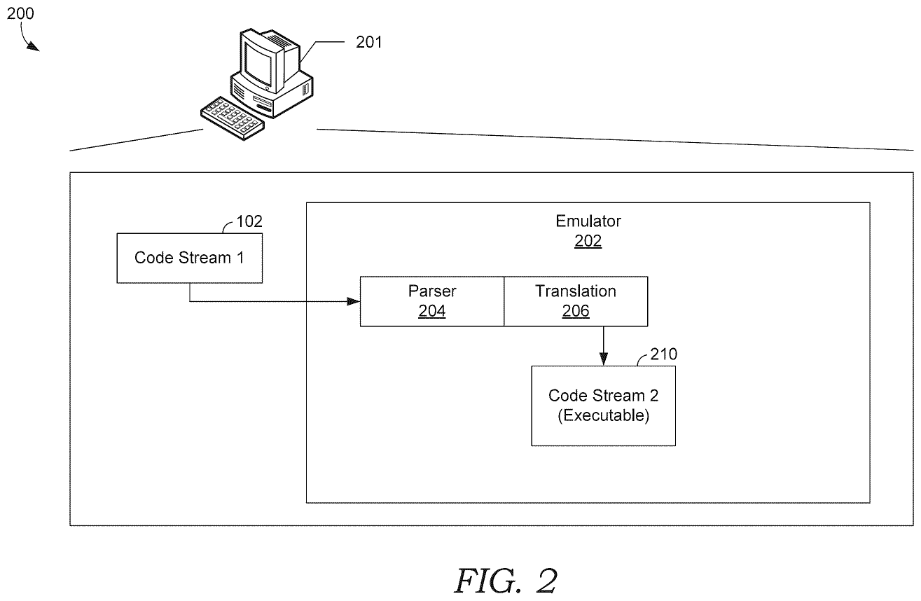

Referring now to FIG. 2, an example computing system 200 is disclosed which can be configured to execute a translated code stream based on a non-native code stream. The computing system 200 can, in aspects, represent computing system 104b, reflecting the fact that at one time the non-native code stream received at the computing system 200 (for example, at computing device 201) was written for an instruction set architecture supported by a different hardware system.

The computing device 201 is configured to receive a non-native code stream such as code stream 102 in memory and execute that code stream using an emulator 202. As previously discussed, the code stream 102 is a non-native code stream, meaning that it is written for execution on an instruction set architecture that is incompatible with the instruction set architecture of the computing device 201. In some aspects, the computing device 201 operates using an Intel-based instruction set architecture (e.g., IA32, IA32-x64/x86-64, IA64, etc.), while the code stream 102 can be written for any number of other types of instruction set architectures, such as PowerPC, ARM, MIPS, SPARC, or other similarly incompatible system architectures. In other aspects, the non-native code may be Intel-based while the native code may be one of the above-mentioned incompatible codes. Put simply, the non-native and native code may be in any language/format that are incompatible with one another. The emulator 202 can take a number of forms but is typically arranged to parse through the code stream one or more times to decompose the code stream into elements describing its contents to provide efficient executable code using the instruction set architecture of the computing system 200/computing device 201.

The emulator 202 is analogous to emulator 118 of FIG. 1 and is configured to decompose the code stream 102 into its constituent operators and parameters for analysis and translation. As shown in FIG. 2, the emulator 202 includes a parser component 204 and a translation component 206. The parser component 204 generally parses the code stream 102 and identifies types of operators and data contained within the code stream 102. The translation component 206 translates the operators received in the code stream 102 into native, translated operators executable on the computing system 200.

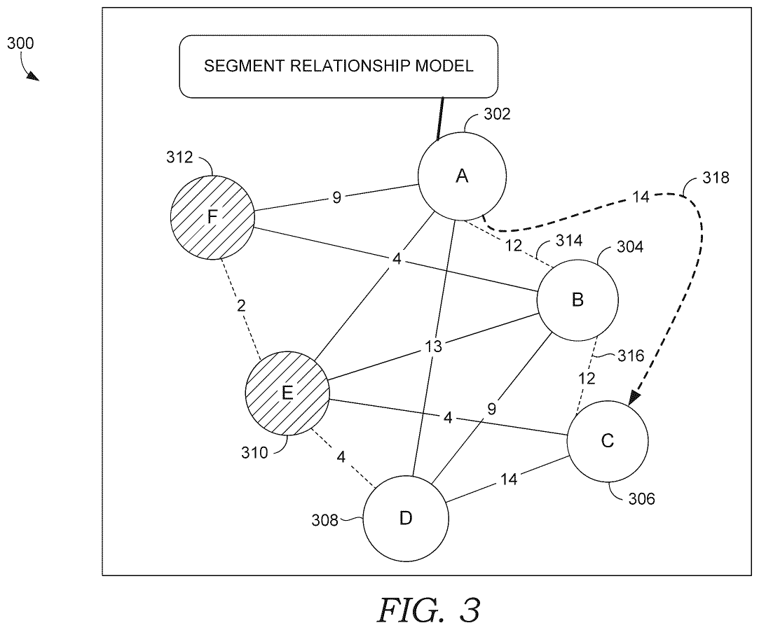

The parser component 204 can also identify a plurality of code relationships between one or more portions of the code stream 102 or code segments, etc. These relationships can be organized in a relationship model/graph, as illustrated in FIG. 3 by a relationship graph 300. As is shown, an exemplary code stream has been parsed and segmented into one or more portions of code or segments, such as code segment 302, code segment 304, code segment 306, code segment 308, code segment 310, and code segment 312. The code segments can be described as nodes of the relationship graph 300 while the edges represent relationships among segments. As shown, edge 314 indicates a relationship between code segment 302 and code segment 304. Similarly, edge 318 indicates a relationship between code segment 302 and code segment 306; edge 316 indicates a relationship between code segment 304 and code segment 306, and so on. Each edge can be associated with a relationship indicator that indicates a strength of a relationship or weight of the relationship. For instance, the relationship graph 300 includes relationship indicators as numerical values, such that edge 318 is associated with a numerical value of 14, edge 314 is associated with a numerical value of 12, and edge 316 is associated with a numerical value of 12. The weights/relationship indicator can be determined using various factors such as call count, translation time, code size, etc. Because the example environment is run using an emulator, the relationships between code segments are identifiable for optimized translation. The relationship graph 300 is maintained even if a program ceases to execute (e.g., in a database/memory, for example, such as memory 108b of FIG. 1). Thus, the relationship data of the graph 300 will be immediately available in the event the program does begin to execute again.

This relationship analysis allows for pre-translation of code segments once a relationship is established. In contrast to hot paths, no predetermined threshold is required to translate. Rather, a relationship of a predetermined weight can be immediately translated, even pre-translated prior to runtime. It is important to note that the non-native code stream is still continuously translated to the native code language by dynamic binary translation performed by, for example, the translation component 206. Such pre-translation saves valuable time during runtime as the related code segments are already translated and in native format.

The order in which dependent code segments (e.g., related code segments having a relationship) from a non-native code stream are translated impacts performance consistency. As an example, consider 4 dependent code segments: A, B, C, and D. Four code segments can be translated in 24 different ways:

| | |
|---|---|
| C-A-B-D | A-B-C-D |
| C-A-D-B | A-B-D-C |
| C-B-A-D | A-C-B-D |
| C-B-D-A | A-C-D-B |
| C-D-A-B | A-D-B-C |
| C-D-B-A | A-D-C-B |
| D-A-B-C | B-A-C-D |
| D-A-C-B | B-A-D-C |
| D-B-A-C | B-C-A-D |
| D-B-C-A | B-C-D-A |
| D-C-A-B | B-D-A-C |
| D-C-B-A | B-D-C-A |

The order of translation may be different each time using only a hot path determinative system. Hot paths are achieved at different rates than others (e.g., system-dependent if the system is busier than usual, user-dependent, time of day-dependent, etc.). For instance, if a system is busy, some translations may be slowed down that are generally prioritized (e.g., hot paths) while others may go ahead due to a smaller translation size. Thus, the order can change. The most-performed order (e.g., hot paths) has around a 4% likelihood of being the most optimized translation order without looking any further than hot paths; that is, not taking code relationships into account. As the number of variables/code segments increases, the likelihood of being correct in a translation using only hot paths continues to decrease.

Because the described environment is emulated, it is possible to identify code relationships. Specifically, it is possible to identify when A calls B, B calls C, C calls D, and so on. This is not currently tracked or utilized for translation. As code is emulated, if the activity between each code segment is tracked, it can be determined that a relationship exists between code segments. For instance, if A tends to call C, then B, then D, the order may be determined to be A-C-B-D such that when A is translated in the future, translation of C can also be initiated (since we know that A will result in a call to C-B-D because of the relationships therebetween). By way of another example, if A-B and A-D are identified as hot paths but F is not, F will not be translated using only hot paths. However, F can be pre-translated as it will be identified as having a relationship with code segment 302 (A). Specifically, code segment 302 (A) may, for example, call on code segment 312 (F). Thus, the relationship determination aids in determining the translation sequence.

Additionally, a hot path may identify a frequency of calls, but not how one code segment relates to another. For instance, a hot path of A-C-D may be identified, but not that C calls B. While it is true that if something is called out of a hot path it itself may translate, but it may translate at a very different rate. For instance, assume in a loop identified as a hot path, a piece of code is only called 10% of the time in the actual hot path. This may not be identified as a hot path itself because of the low call frequency. You may have to wait ten times as long to translate the piece of code called at 10% because of the hot path threshold and the inherent characteristic of hot paths that only evaluates frequency, not relationships. Put another way, hot paths do not identify where a call came from or where it is going. By way of another example, eventually, if Z is a hot path and Z calls Y, Y will eventually be translated in typical systems. Assume a hot path threshold of 10K iterations. If you go around loop Z 100K times, Z will be translated within 10K iterations. But if you have code within the loop that is only called 10% of the time, it will take the entire execution of loop Z (100K iterations) for Y to be translated, even though there is a relationship between Z and Y. Y isn't “hot” enough or being called enough in the hot path to rise to the threshold.

In contrast, a relationship graph indicates that the piece of code is called and establishes a relationship between the code segments. Thus, as Z is processed the relationships are captured and it is determined that Y needs to be translated close to Z to ensure consistent performance.

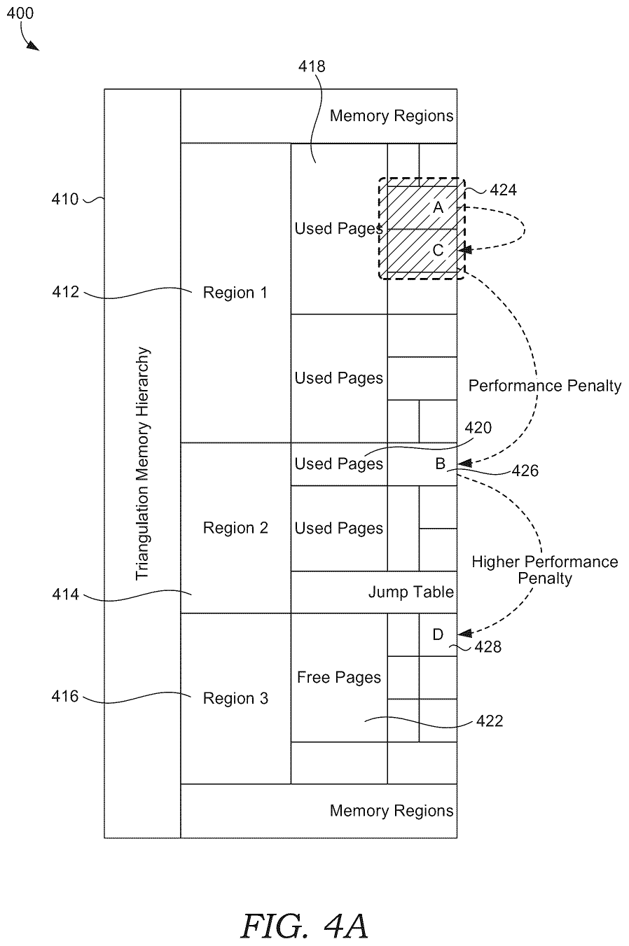

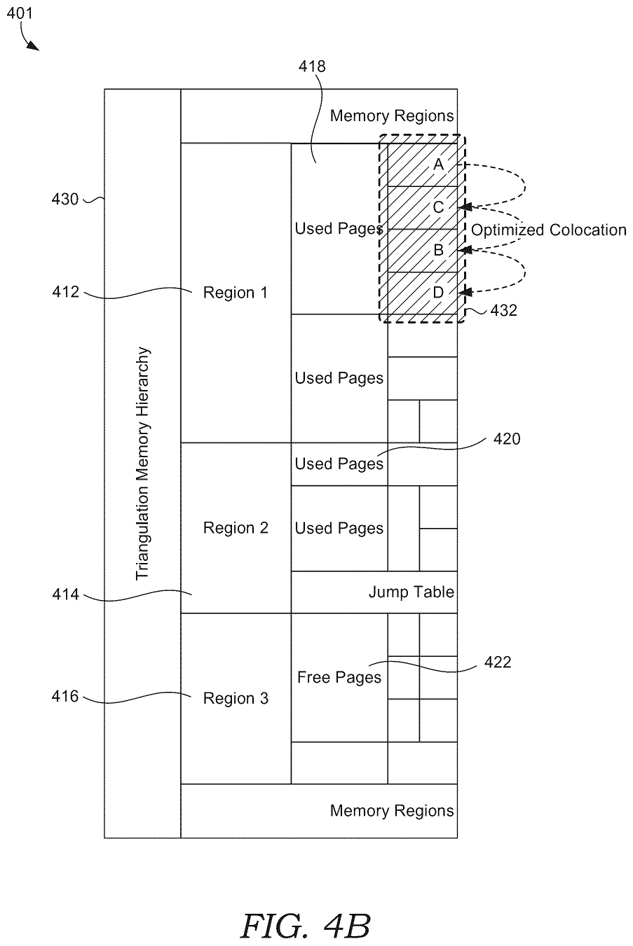

Returning to FIG. 2, based on the parser component 204 and the translation component 206, an executable code stream 210 is generated. Optimized translation due to relationships is a key piece of the optimization, but intelligent storage is also a feature of this technology. FIG. 4A illustrates the shortcomings of typical storage, while FIG. 4B is a feature of the technology described herein for intelligent storage of optimized translations.

FIG. 4A depicts a table 400 of a storage environment 410. The storage environment 410 includes Region 1 412, Region 2 414, and Region 3 416. Each region is associated with one or more pages illustrated as pages area 418, pages area 420, and pages area 422. Typical systems may utilize 4K pages, referring to a memory page that is 4 kilobytes (KB) in size. As illustrated in FIG. 4A, code segments A and C are stored together at location 424 at pages area 418 in Region 1 412. However, code segment B is stored at location 426 at pages area 420 in Region 2 414 while code segment D is stored at yet another different location at location 428 at pages area 422 in Region 3 416. As shown, as the system accesses different page area at different locations, the performance suffers. This method of storage is largely due to the hot path translation approach, where code segments are translated at different rates. For instance, if A is the hottest, then C, then B, then D and over time it takes 10 seconds for A to become hot, 1 minute for C to become hot, 5 minutes for B, and 6 minutes for D, the period of time has increased such that the likelihood you have for locality is minimal. Systems are dynamic and memory is used constantly by various components, so memory allocation of a runtime translation is not going to be co-located unless done immediately in sequence, which is not possible with hot paths. Even with only a few seconds between translations, the translated segments could end up in widely different areas of memory.

FIG. 4B illustrates the co-located memory approach of the technology described herein, made possible due to optimized translation based on code relationships. Co-location can be achieved because of the understanding of the code relationships. Translations occur closer together (e.g., less time elapses between translations of related code segments) because the code relationship is identified and then sequentially translated. Because less time elapses, the higher likelihood that the translated code will be co-located, as illustrated in FIG. 4B.

FIG. 4B depicts a table 401 of a storage environment 430. Storage environment 430 includes the same basic architecture as shown in FIG. 4A including regions 412, 414, and 416 and pages areas 418, 420, and 422. As shown in FIG. 4B, code segments A, C, B, and D are co-located at pages area 418 in Region 1 412. In aspects, code segments A, C, B, and D could be made an atomic unit such that they are translated as one unit. This would ensure co-location. Sequential translation, made possible by code relationships, also results in co-location. In aspects, pre-allocation of memory can be utilized as well in order to ensure co-locality. As such, a first portion of memory could be reserved prior to translation for code segments A, C, B, and D, such that they are co-located. Co-location improves code density, reduces fragmentation in memory, reduces cache misses, and the like.

In aspects, code relationships may be prioritized. Critical relationships, for example, can be given higher priority level than non-critical relationships. A critical relationship, as used herein, refers generally to a code segment within an operating system. For instance, if a code segment at the operating system versus user program level is being translated, a priority level can be given to the code residing at the operating system level, rather than the user program level. Again, because the system is emulated herein, it is known whether the code is at the operating system level or the user program level. Thus, priorities can be assigned to relationships such that a relationship within the operating system is higher priority level than a relationship outside of the operating system. Furthermore, relationships that are at the operating system are also prioritized as well. For instance, a call to read or write a file to a server is not a call that should be delayed while other operating system services (e.g., printing, authentication, etc.) that are not core to the operating system should be translated but not at as high a priority as core operating systems code. This also relates to the relationships therein. Put simply, if an operating system service calls on three other services, a relationship is established and prioritized accordingly. These relationships can also be translated as a unit so that they are all available when needed. Further, the priorities can be configurable values and modified as desired.

Such prioritizations may be dynamic in nature. In aspects, workload adaptation is taken into account to re-prioritize relationships as needed. For instance, many systems utilize a specific workflow during daylight/working hours (e.g., 8am-5pm) but then afterwards a different workflow is used. A certain set of relationships may need to be translated and available during the workday while the system can prioritize other translations overnight that are not needed during the day. Thus, prioritization of translation may dynamically update based on time of day.

In aspects, metadata of the code segments can be identified to prioritize the code relationships. Metadata of the code segments can include a size of the code segment, a translation time of the code segment, and the like. By way of example, assume that a process time allocated to a process is X but the code segment translation time for a piece of code is greater than X. Other portions of code that are called may be prioritized over the large code segment to maximize translations for the time allocation X.

The technology, as described above, provides advantages over current solutions since optimized translations described herein do not rely on hot paths or frequency thresholds to be translated. Pre-translating of known code relationships is possible using technology herein and aids in the overall performance and performance consistency.

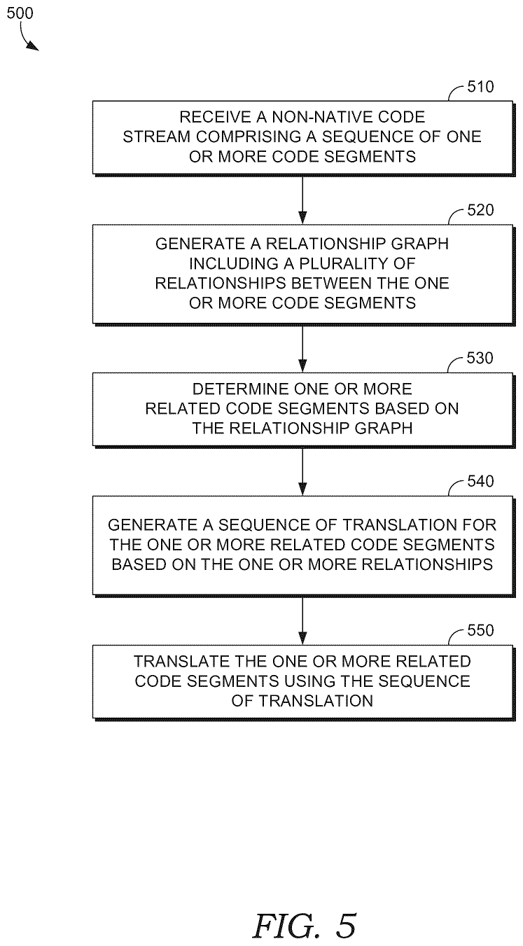

FIG. 5 is a flow diagram showing a method 500 of an example process flow for optimized translations, in accordance with some aspects of the technology. At block 510, a non-native code stream comprising a sequence of one or more code segments is received. At block 520, a relationship graph is generated that includes a plurality of relationships between the one or more code segments. One or more related code segments is determined at block 530 based on the relationship graph. At block 540, a sequence of translation is generated for the one or more related code segments based on the one or more relationships of the relationship graph. At block 550, the one or more related code segments is translated using the sequence of translation. The sequence of translation can be updated due to changes in the relationships (e.g., a new code segment is introduced and is called, such that a new relationship exists) and an updated sequence of translation can be created.

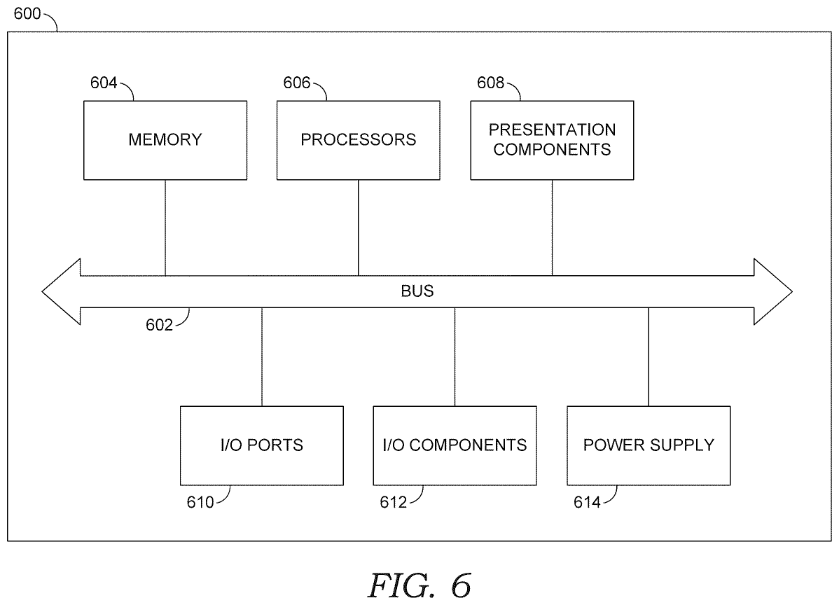

Having described embodiments of the present disclosure, FIG. 6 provides an example of a computing device in which embodiments of the present disclosure may be employed. Computing device 600 includes bus 602 that directly or indirectly couples the following devices: memory 604, one or more processors 606, one or more presentation components 608, input/output (I/O) ports 610, input/output components 612, and power supply 614. Bus 602 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 6 is merely illustrative of an exemplary computing device that can be used in connection with one or more aspects of the technology. Distinction is not made between such categories as “workstation,” “server,” “laptop,” “handheld device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 604 includes computer storage media in the form of volatile and/or nonvolatile memory. Memory 604 may include instructions (not shown in FIG. 6). Instructions, when executed by processor(s) 606 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 600 includes one or more processors that read data from various entities such as memory 604 or I/O components 612. Presentation component(s) 608 present data indications to a user or other device. Exemplary presentation components include a display device, speaker, printing component, vibrating component, etc.

I/O ports 610 allow computing device 600 to be logically coupled to other devices including I/O components 612, some of which may be built in. Illustrative components include a microphone, joystick, game pad, satellite dish, scanner, printer, wireless device, etc. I/O components 612 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 600. Computing device 600 may be equipped with depth cameras, such as stereoscopic camera systems, infrared camera systems, RGB camera systems, and combinations of these, for gesture detection and recognition. Additionally, computing device 600 may be equipped with accelerometers or gyroscopes that enable detection of motion. The output of the accelerometers or gyroscopes may be provided to the display of computing device 600 to render immersive augmented reality or virtual reality.

Embodiments presented herein have been described in relation to particular embodiments that are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order to not obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C); (A and B); (A and C); (B and C); or (A, B and C).”

It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 6.

It should be understood that computing environments shown herein (e.g., FIGS. 1 and 2) are merely examples of suitable operating environments. Each of the components shown in FIGS. 1 and 2 can be implemented via any type of computing device, such as one or more computing devices 600 described in connection with FIG. 6, for example. These components can communicate with each other via a network (not shown), which can be wired, wireless, or both. The network can include multiple networks, or a network of networks, but is shown in simple form so as not to obscure aspects of the present disclosure. By way of example, the network can include one or more wide area networks (WANs), one or more local area networks (LANs), one or more public networks such as the Internet, and/or one or more private networks. Networking environments are commonplace in offices, enterprise-wide computer networks, intranets, and the Internet. Accordingly, the network is not described in significant detail.

It should be understood that any number of devices, servers, and other components can be employed within the operating environment within the scope of the technology described herein. Each can comprise a single device or multiple devices cooperating in a distributed environment. For example, the computing environment may include multiple server computer systems cooperating in a distributed environment to perform the operations described in the present disclosure.

What is claimed is:

1. A method for optimized translation in a computing system, comprising:
receiving, by a processor of the computing system, a non-native code stream comprising a sequence of one or more code segments;
generating a relationship graph including a plurality of relationships between the one or more code segments;
determining one or more related code segments based on the relationship graph;
generating a sequence of translation for the one or more related code segments based on the one or more relationships; and
translating the one or more related code segments using the sequence of translation.

2. The method of claim 1, further comprising identifying one or more hot paths during runtime to translate after the one or more related code segments.

3. The method of claim 1, further comprising, creating an instruction to allocate memory for the one or more related code segments.

4. The method of claim 1, further comprising storing the one or more related code segments in contiguous memory location.

5. The method of claim 1, further comprising assigning a priority level to a first code segment of the one or more related code segments and a second code segment of the one or more related code segments.

6. The method of claim 5, wherein the priority level of the first code segment is higher than the priority level of the second code segment, wherein the first code segment is translated before the second code segment.

7. The method of claim 5, wherein the first code segment is a code segment within an operating system.

8. The method of claim 1, further comprising:
updating the relationship graph based on a change in the plurality of relationships; and
generating an updated sequence of translation for the one or more related code segments based on the change in the plurality of relationships.

9. The method of claim 1, wherein translating the one or more related code segments using the sequence of translation is a pre-translation that occurs prior to runtime.

10. The method of claim 1, further comprising maintaining the relationship graph for the non-native code stream in storage even after the non-native code stream is no longer executed at the computing system.

11. One or more computer storage media having executable instructions embodied thereon, which, when executed by a processor, cause the processor to perform operations to a memory architecture in a computing system, the operations comprising:
receiving, by a processor of the computing system, a non-native code stream comprising a sequence of one or more code segments;
generating a relationship graph including a plurality of relationships between the one or more code segments;
determining one or more related code segments based on the relationship graph;
generating a sequence of translation for the one or more related code segments based on the one or more relationships; and
translating the one or more related code segments using the sequence of translation.

12. The media of claim 11, wherein the operations further comprise identifying one or more hot paths during runtime to translate after the one or more related code segments.

13. The media of claim 11, wherein the operations further comprise creating an instruction to allocate memory for the one or more related code segments.

14. The media of claim 11, wherein the operations further comprise storing the one or more related code segments in contiguous memory location.

15. The media of claim 14, wherein the contiguous memory location is a same page of memory.

16. The media of claim 11, wherein the operations further comprise updating the relationship graph based on a change in the plurality of relationships.

17. The media of claim 16, wherein the operations further comprise prioritizing the one or more related code segments for translation.

18. The media of claim 17, wherein the prioritizing includes identifying a time of day.

19. The media of claim 18, wherein a first code segment is a higher priority at a first time than it is at a second time.

20. A system comprising:
a processor; and
a memory architecture in a computing system coupled to the processor storing instructions that, as a result of being executed by the processor, cause the processor to:
receive, by a processor of the computing system, a non-native code stream comprising a sequence of one or more code segments;
generate a relationship graph including a plurality of relationships between the one or more code segments;
determine one or more related code segments based on the relationship graph;
generate a sequence of translation for the one or more related code segments based on the one or more relationships; and
translate the one or more related code segments using the sequence of translation.
